(19) United States
(12) Patent Application Publication
(10) Pub. No.: US 2008/0250324 A1
(43) Pub. Date: Oct. 9, 2008

(54) REMOTE INSTRUCTION SYSTEM, IMAGE FORMING APPARATUS, CONTROL METHOD, AND STORAGE MEDIUM

(75) Inventor: Chie Ito, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/045,505

(22) Filed: Mar. 10, 2008

(30) Foreign Application Priority Data
Apr. 3, 2007 (JP) 2007-097486

(51) Int. Cl. G06F 3/048; G06F 15/173

(52) U.S. Cl. 715/736

(57) ABSTRACT

An image forming apparatus connected to an information processing apparatus via a network acquires display data to be used when an operation screen for entering an instruction to be given to the information processing apparatus is displayed, analyzes the acquired display data, outputs a first instruction sheet to be filled in with an instruction to the information processing apparatus according to a result of the analysis, reads a second instruction sheet that is the first instruction sheet filled in with a user's instruction, and transmits, to the information processing apparatus, instruction information indicating content of the user's instruction recognized from the read second instruction sheet.

### BACKGROUND OF THE INVENTION

1. Field of the Invention

The present invention relates to a remote instruction system configured to output an instruction sheet to be filled in with a user's instruction based on display data used when an operation screen is displayed to enter an instruction from a user, and also relates to an image forming apparatus, a control method, and a storage medium.

2. Description of the Related Art

Recently, a configuration where a plurality of information processing apparatuses are interconnected via a local area network (LAN) to function in cooperation has become widespread not only in corporations but also in other settings, such as individual households. Examples of information processing apparatuses connected via a LAN include personal computers (PCs), network printers, and network scanners.

Also, household electric appliances connectable to a network have recently come into wide use. For example, a hard disk drive (HDD) recorder or a music player can be connected to the network to download various types of content. Household electric appliances connectable to a network are not limited to such apparatuses, but an air conditioner, a refrigerator, and a washing machine can be made compatible for connecting to a network.

Such information processing apparatuses include the one that has a web server function and can provide a HyperText Markup Language (HTML) file to be displayed as a user interface (UI) screen in another information processing apparatus via the Internet or LAN.

For example, Japanese Patent Application Laid-Open No. 2004-186826 discusses a recording/reproducing apparatus, which executes a web server program provided therein to enable a user to instruct various settings from a web browser program running in a PC connected via a network. Specifically, a web browser of the PC displays a UI screen based on an HTML file transferred from the recording/reproducing apparatus, and reading of a recording reservation list, reserving of new recording, or changing of reservation content can be instructed according to an instruction entered by using the UI screen.

If various information processing apparatuses include web server functions as described above, it obviates the necessity for a user to take the trouble to go to an information processing apparatus every time to instruct an operation. Thus, greater convenience can be provided especially for the aged and the handicapped.

As a method for instructing an operation of an information processing apparatus from a remote place, for example, a mark-sensing sheet may be used as discussed in Japanese Patent Application Laid-Open No. 06-113049. Japanese Patent Application Laid-Open No. 06-113049 discusses a method in which a user can write a desired instruction in a mark-sensing sheet prepared beforehand to set functions and can operate a facsimile machine to read the mark-sensing sheet. The facsimile machine gives instructions for an operation to a telephone set connected via a telephone line.

However, the following problems have been found in the aforementioned conventional art. Even if an information processing apparatus, including a household electric appliance, connected via a LAN has a web server function as discussed in Japanese Patent Application Laid-Open No. 2004-186826, a user cannot give any instructions from a remote place without operating a web browser installed in a PC.

In other words, for example, if there is no information processing apparatus, such as a PC, that has a web browser function at home, the user cannot perform setting using a UI screen displayed based on an HTML file provided from a web browser. Even if there is a PC that includes a web browser at home, operating the web browser to instruct a desired operation still involves complicated work especially for the aged and unsophisticated users for a PC operation, and thus degrades usability.

As discussed in Japanese Patent Application Laid-Open No. 06-113049, by using the mark-sensing sheet, even the unsophisticated user for a PC operation can easily instruct a desired operation. However, with regard to conventional mark-sensing sheets, a mark-sensing sheet prepared for each respective information processing apparatus (a telephone set in the case of Japanese Patent Application Laid-Open No. 06-113049) by a maker has to be used. Thus, as the number of types of information processing apparatuses to be instructed to operate from a remote place increases, the number of types of mark-sensing sheets to be prepared beforehand becomes greater, thus necessitating time and labor for managing mark-sensing sheets.

When an operation of a household electric appliance installed at home is instructed, the aforementioned mark-sensing sheet can be used. However, problems occur if various applications or registrations are entered by using HTML files provided from a web server via the Internet. In other words, in such a case, no mark-sensing sheet can be prepared beforehand, and a user has to enter desired information by operating a web server.

### SUMMARY OF THE INVENTION

An embodiment of the present invention is directed to a remote instruction system configured to analyze display data provided from an information processing apparatus connected via a network and to output an instruction sheet to be filled in with a user s instruction, an image forming apparatus, a control method, and a storage medium.

According to an aspect of the present invention, a remote instruction system includes an information processing apparatus and an image forming apparatus. The information processing apparatus and the image forming apparatus are interconnected via a network. The information processing apparatus includes a storage unit configured to store display data to be used when an operation screen for entering an instruction to be given to the information processing apparatus is displayed, a display data transmission unit configured to transmit the display data stored in the storage unit to an external apparatus in response to a request from the external apparatus, an instruction information receiving unit configured to receive, from the external apparatus, instruction information indicating content of an instruction entered by a user using the operation screen displayed based on the display data in the external apparatus, and a control unit configured to control an operation of the information processing apparatus based on the instruction information received by the instruction information receiving unit. The image forming apparatus includes a display data receiving unit configured to receive the display data from the information processing apparatus, an analysis unit configured to analyze the display data received by the display data receiving unit, an output unit configured to output a first instruction sheet to be filled in with an instruction to the information processing apparatus according to a result of analysis by the analysis unit, a reading unit configured to read a second instruction sheet that is the first instruction sheet output by the output unit and filled in with a user's instruction, and an instruction information transmission unit configured to transmit, to the information processing apparatus, instruction information indicating content of the user's instruction recognized from the second instruction sheet read by the reading unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a remote instruction system according to a first exemplary embodiment of the present invention.

FIG. 2 is a system block diagram of a multifunction peripheral (MFP) according to the first exemplary embodiment.

FIG. 3 is a system block diagram of a refrigerator according to the first exemplary embodiment.

FIG. 4 is a flowchart illustrating a communication operation between the refrigerator and a PC according to the first exemplary embodiment.

FIG. 5 illustrates an operation screen displayed in the PC according to the first exemplary embodiment.

FIG. 6 illustrates an operation screen displayed in the PC according to the first exemplary embodiment.

FIG. 7 illustrates an operation screen displayed in the PC according to the first exemplary embodiment.

FIG. 8 is a flowchart illustrating an operation of the MFP according to the first exemplary embodiment.

FIG. 9 illustrates an operation screen displayed in the MFP according to the first exemplary embodiment.

FIG. 10 is a flowchart illustrating an operation of the MFP according to the first exemplary embodiment.

FIG. 11 illustrates a printout obtained by printing an operation screen according to the first exemplary embodiment.

FIG. 12 illustrates an instruction sheet according to the first exemplary embodiment.

FIG. 13 is a flowchart illustrating an operation of the MFP according to the first exemplary embodiment.

FIG. 14 illustrates display data according to the first exemplary embodiment.

FIG. 15 is a flowchart illustrating an operation of the MFP according to the first exemplary embodiment.

FIG. 16 illustrates an instruction sheet according to the first exemplary embodiment.

FIG. 17 illustrates an operation screen displayed in the MFP according to the first exemplary embodiment.

FIG. 18 is a flowchart illustrating an operation of the refrigerator according to the first exemplary embodiment.

FIG. 19 is a flowchart illustrating an operation of an MFP according to a second exemplary embodiment of the present invention.

FIG. 20 illustrates an instruction sheet according to the second exemplary embodiment.

FIG. 21 illustrates an entire system according to a third exemplary embodiment of the present invention.

FIG. 22 is a flowchart illustrating an operation of an MFP according to the third exemplary embodiment.

FIG. 23 is a flowchart illustrating an operation of the MFP according to the third exemplary embodiment.

### DETAILED DESCRIPTION OF THE EMBODIMENTS

Various exemplary embodiments, features, and aspects of the invention will be described in detail below with reference to the drawings.

### First Exemplary Embodiment

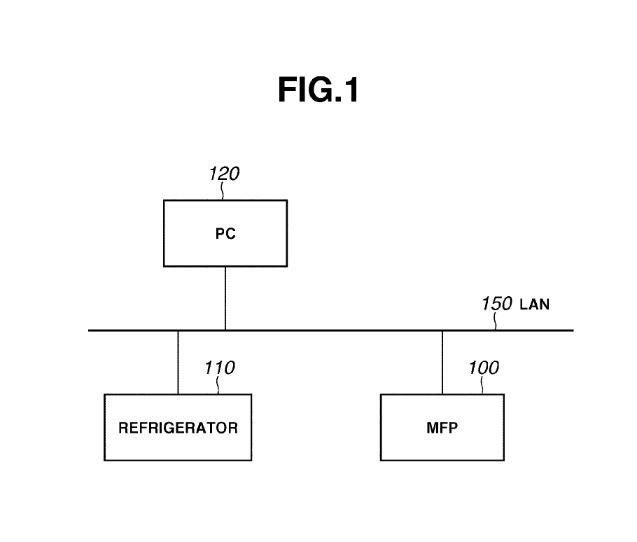

FIG. 1 illustrates a remote instruction system according to a first exemplary embodiment of the present invention. According to the first exemplary embodiment, an MFP 100, which is an example of an image forming apparatus, a refrigerator 110, which is an example of an information processing apparatus, and a personal computer (PC) 120 are interconnected via a network (e.g., LAN 150).

The refrigerator 110 has a web server function installed therein. By using an HTML file provided from the web server function, an external apparatus (for example, the PC 120 or MFP 100) connected via a network can generate and transmit an instruction to the refrigerator 110.

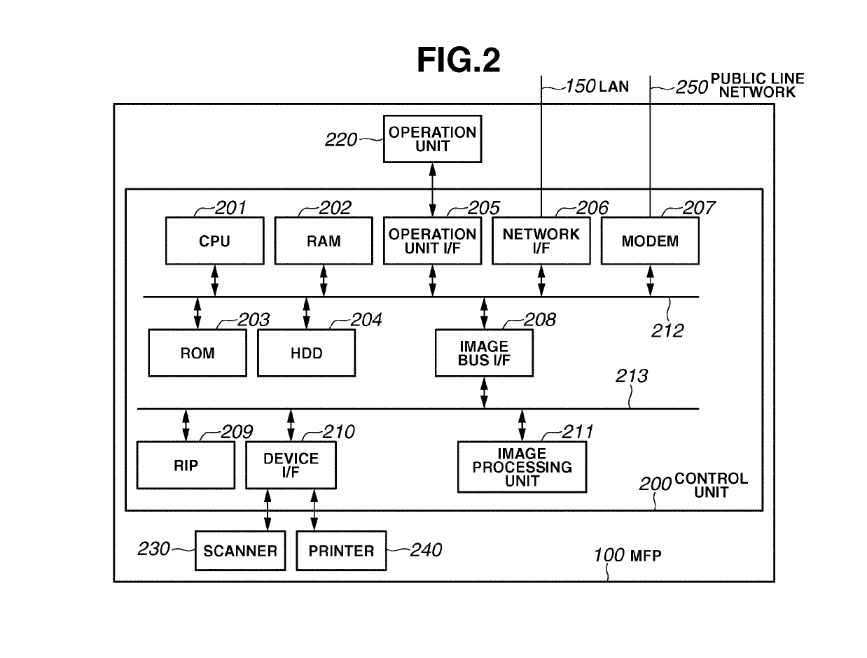

FIG. 2 is a system block diagram of the MFP 100, which is an example of an image forming apparatus. The MFP 100 includes a control unit 200. The control unit 200 is connected to a scanner 230, which is an image reading unit, and a printer 240, which is an image outputting unit. The control unit 200 is also connected to the LAN 150 and a public line network 250. The control unit 200 controls an overall operation of the MFP 100 when various functions, such as a scanner function, a printer function, a copy function, and a facsimile function, are executed.

The control unit 200 includes a central processing unit (CPU) 201. The CPU 201 activates the MFP 100 based on a boot program stored in a read-only memory (ROM) 203. The CPU 201 reads various control programs stored in a hard disk drive (HDD) 204 to execute various processes by using a random access memory (RAM) 202 as a work area. The HDD 204 stores image data together with the various control programs.

An operation interface (I/F) 205 is an interface for connecting the control unit 200 with an operation unit 220. The operation I/F 205 transfers image data to be displayed in the operation unit 220 to the same, or notifies an instruction entered in the operation unit 220 by a user to the CPU 201. The operation unit 220 includes a liquid crystal panel unit, which has a touch panel function for recognizing instructed content based on screen position information of a place touched by the user.

A network I/F 206 is connected to the LAN 150, and communicates various data with another terminal (for example, the refrigerator 110 or PC 120) on the network via the LAN 150. A modem 207 is connected to the public line network 250 and inputs/outputs information via the public line network 250.

An image bus I/F 208 serves as a bus bridge for interconnecting an image bus 213 and a system bus 212 to convert a data structure. For the image bus 213, for example, a Peripheral Components Interconnect (PCI) bus or a bus complaint with Standard of IEEE 1394, which can transfer image data at a high speed, is used.

A raster image processor (RIP) 209 rasterizes page description language (PDL) code into a bitmapped image. A device I/F 210 connects the scanner 230 or the printer 240 to the control unit 200 to input/output image data. An image processing unit 211 performs various processes, such as correction, processing, and editing, for image data input from the scanner 230. The image processing unit 211 further performs various processes, such as correction and resolution changing, for image data to be output from the printer 240. The image processing unit 211 can also perform rotation, multivalue/binary conversion, or compression/decompression of an image.

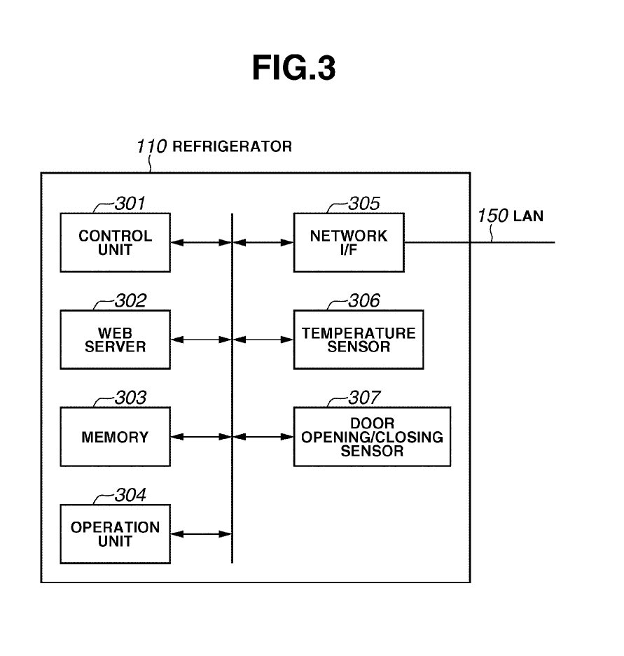

FIG. 3 is a system block diagram of the refrigerator 110. The first exemplary embodiment will be described by using a refrigerator as an example of an information processing apparatus. However, an information processing apparatus other than a refrigerator can be used as long as it has a web server function as described below. More specifically, the present invention can be applied to various household electric appliances/information terminals, such as a television set, a DVD recorder, a digital video recorder, a music player, an air conditioner, a washing machine, a telephone set, a scanner, a printer, and a facsimile machine.

A control unit 301 controls an overall operation of the refrigerator 110. A temperature sensor 306 and a door opening/closing sensor 307 respectively detect an in-refrigerator temperature and a door opened/closed state to notify the results to the control unit 301. The control unit 301 controls setting of the in-refrigerator temperature or switching of various modes of the refrigerator 110 according to an instruction entered by the user via an operation unit 304.

A network I/F 305 connects the refrigerator 110 to the LAN 150 to input/output various pieces of information. A web server 302 reads, according to a request from the external apparatus on the network, display data used when an operation screen for instructing an operation of the refrigerator 110 is displayed from a memory 303 to transmit the data to the requesting external apparatus via the network I/F 305. The display data is stored in the memory 303 in HTML format.

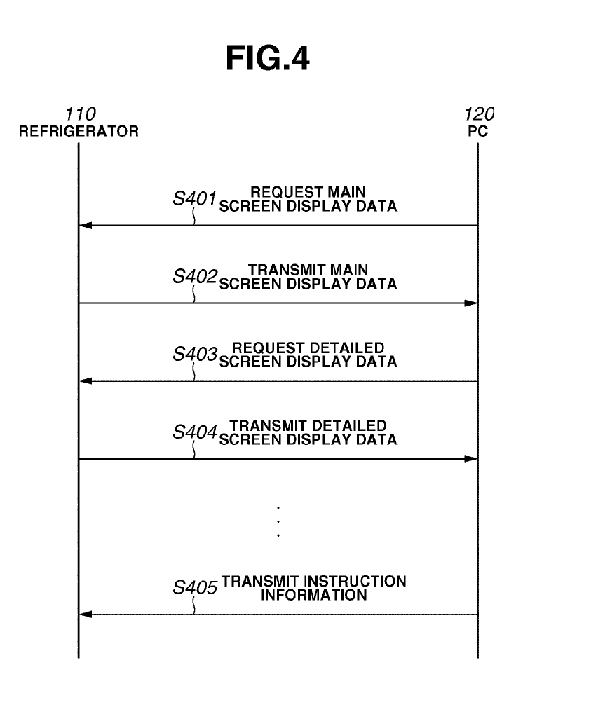

FIG. 4 is a flowchart illustrating a series of operations where the refrigerator 110 transmits an HTML file according to a request from the PC 120 as an external apparatus, and receives, from the PC 120, information indicating content of an instruction entered by the user in the PC 120. It should be noted that the series of operations are controlled by a control unit (not shown) of the PC 120 and the control unit 301 of the refrigerator 110 based on programs stored in a memory (not shown) of the PC 120 and the memory 303 of the refrigerator 110.

First, in step S401, the PC 120 requests display data (HTML file) for displaying a main screen to the refrigerator 110. In step S402, in response to this request, the web server 302 of the refrigerator 110 reads display data stored in the memory 303 for displaying a main screen, and the network I/F 305, which is a display data transmission unit, transmits the display data to the PC 120. According to the display data received by a display data receiving unit (not shown) of the PC 120, the PC 120 displays an operation screen on a display unit (not shown) of the PC 120.

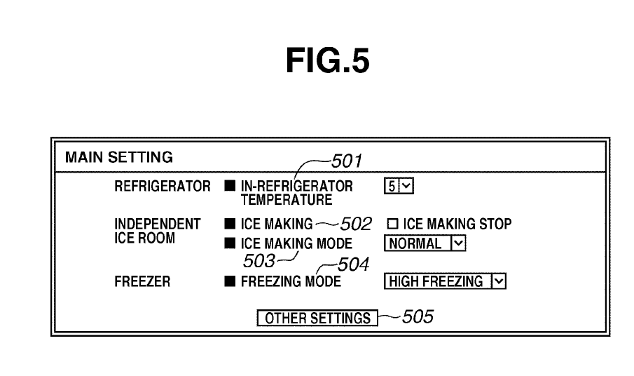

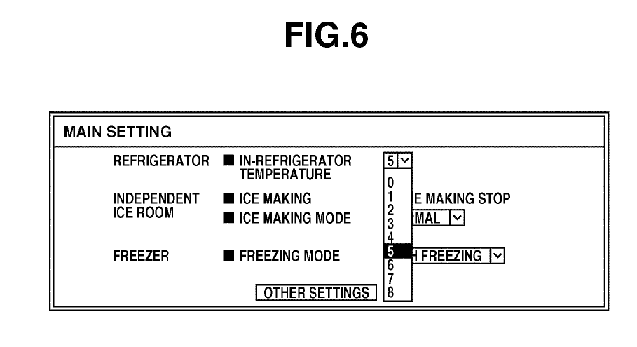

FIG. 5 illustrates a main screen displayed as the operation screen in the PC 120. The user can enter an operation instruction for the refrigerator 110 by using the operation screen illustrated in FIG. 5. An area 501 is provided for instructing setting of an in-refrigerator temperature of the refrigerator 110. The user can select a desired temperature among options displayed in a dropdown list format as illustrated in FIG. 6. In an example illustrated in FIG. 5, 5° C. is set as an in-refrigerator temperature.

An area 502 is provided for instructing whether to automatically make ice by using a check box. In the example illustrated in FIG. 5, as there is no checking in the check box of the area 502, execution of ice making is instructed.

An area 503 is provided for instructing which of ice making modes is used to make ice when the execution of ice making is instructed in the area 502. The refrigerator 110 has three ice making modes, “NORMAL”, “HIGH SPEED”, and “SUPERHIGH SPEED”. The user can instruct a desired ice making mode among options displayed in a dropdown list format as in the case of the area 501.

An area 504 is provided for instructing which of three freezing modes, “NORMAL FREEZING”, “HIGH FREEZING”, and “LOW FREEZING”, of the refrigerator 110 is set. As in the case of the area 501, options are displayed in a dropdown list format. In the example illustrated in FIG. 5, “HIGH FREEZING” is selected.

When the user wishes to instruct more detailed setting, the user can press an “OTHER SETTINGS” button 505 displayed in a lower end of the screen. Upon pressing of the button 505, in step S403 of FIG. 4, the PC 120 requests display data for displaying a detailed screen to the refrigerator 110.

In step S404, the web server 302 of the refrigerator 110, which has received the request, reads an HTML file stored in the memory 303 for displaying a detailed screen and transmits the HTML file to the PC 120. Based on the received HTML file, the PC 120 displays an operation screen on the display unit (not shown).

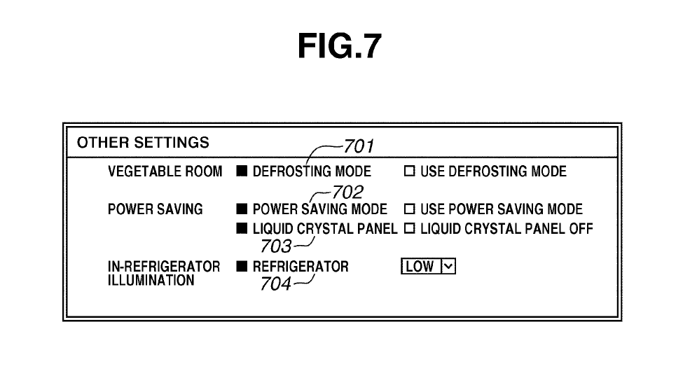

FIG. 7 illustrates a detailed screen displayed in the PC 120. An area 701 is provided for instructing whether to execute “DEFROSTING MODE” of the refrigerator 110 by using a check box. An area 702 is provided for instructing whether to execute “POWER SAVING MODE” of the refrigerator 110 by using a check box.

An area 703 is provided for switching ON/OFF of displaying of the liquid crystal panel installed in the operation unit 304 of the refrigerator 110. An area 704 is provided for selecting one of “LOW”, “MIDDLE”, and “HIGH” illumination modes of a refrigerating room of the refrigerator 110.

In step S405 of FIG. 4, an instruction information transmission unit (not shown) of the PC 120 transmits, to the refrigerator 110, instruction information indicating content of an instruction entered by the user of the PC 120 by using the main screen illustrated in FIG. 5 or the detailed screen illustrated in FIG. 7.

Based on the instruction information received by the network I/F 305, as an instruction information receiving unit, from the PC 120, the control unit 301 of the refrigerator 110 controls an operation of the refrigerator 110. For example, the control unit 301 controls an in-refrigerator temperature or switches various modes according to a user's instruction entered by using the screen illustrated in FIG. 5 or FIG. 7.

Thus, the user can access the refrigerator 110 from a terminal having a web browser function, such as the PC 120, via a network and can give instructions to the refrigerator 110 from a remote place. As a result, the user does not have to go to the refrigerator 110 each time to instruct an operation. Therefore, greater convenience can be provided especially for the aged or the handicapped.

On the other hand, however, if there is no terminal having a web browser function, such as a PC, at home, a user cannot view an HTML file provided by the web server 302 of the refrigerator 110. Thus, the aforementioned convenience cannot be obtained. Even if there is a PC having a web browser at home, usability may not be so high especially for a user, such as the aged, unaccustomed to a PC operation, because the user has to carry out complex work to instruct a desired operation by operating the web browser.

Thus, according to the first exemplary embodiment, the MFP 100 analyzes display data provided from the web server 302 of the refrigerator 110 and outputs an instruction sheet to be filled in with a user's instruction. Accordingly, without any complex operation using the PC 120, a user can give instructions to the refrigerator 110 from a remote place.

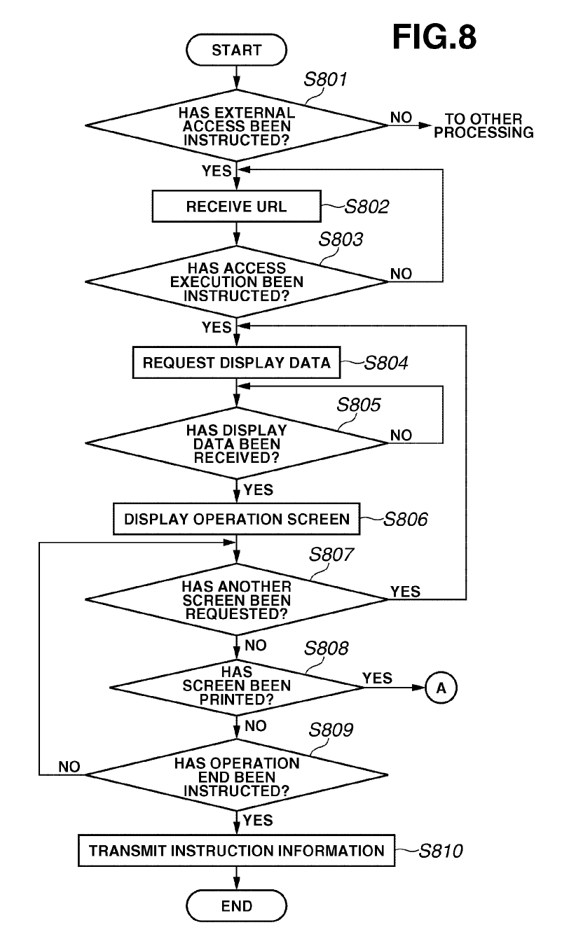

FIGS. 8, 10 and 13 are flowcharts specifically illustrating a series of operations where the MFP 100 obtains and analyzes display data used when an operation screen is displayed from the web server 302 of the refrigerator 110 and prints and outputs an instruction sheet. The CPU 201 of the control unit 200 controls the series of operations of the flowcharts based on programs stored in the HDD 204.

In step S801 of FIG. 8, the CPU 201 determines whether a user has instructed access to an external information processing apparatus via the operation unit 220. If it is determined that the access has been instructed (YES in step S801), the processing proceeds to step S802. If it is determined that the access has not been instructed (NO in step S801), the CPU 201 executes other processing.

In step S802, the CPU 201 displays a screen for allowing the user to designate an external information processing apparatus (for example, the refrigerator 110), which is an access destination, on the liquid crystal panel of the operation unit 220 and receives designation of a URL of the access destination. In step S803, the CPU 201 determines whether execution of access to the external information processing apparatus has been instructed from the user. If it is determined that the user has instructed the execution of access to the external information processing apparatus (YES in step S803), the processing proceeds to step S804. If the user has not instructed (NO in step S803), the CPU 201 continues the URL reception.

In step S804, the CPU 201 accesses the refrigerator 110 based on the URL received in step S802 to request display data to be displayed on the liquid crystal panel of the operation unit 220. In step S805, the CPU 201 determines whether an HTML file transmitted as display data from the refrigerator 110 has been received. If it is determined that the HTML file has been received (YES in step S805), the process proceeds to step S806.

In step S806, based on the HTML file received from the refrigerator 110, the CPU 201 displays an operation screen for entering an instruction to the refrigerator 110 on the liquid crystal panel of the operation unit 220.

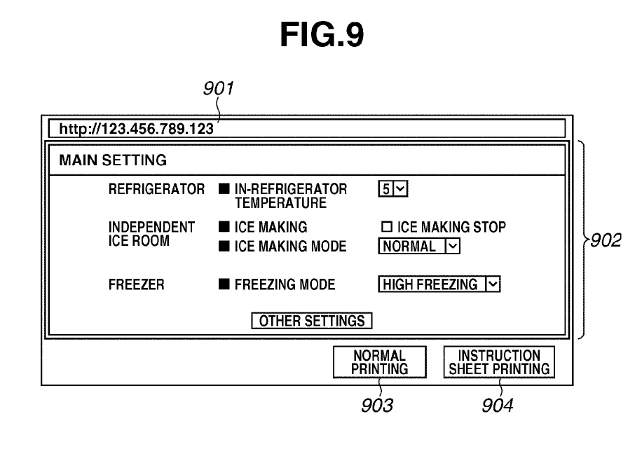

FIG. 9 illustrates the operation screen displayed on the liquid crystal panel of the operation unit 220. An area 901 is provided for displaying the URL received in step S802. As illustrated in FIG. 9, the URL corresponding to the web server 302 of the refrigerator 110 contains an IP address allocated to the refrigerator 110. In such a case, the user can designate only an IP address to access the refrigerator 110.

An area 902 is provided for displaying an operation screen similar to that illustrated in FIG. 5. An area 903 is provided for displaying a button 903 to be pressed when “NORMAL PRINTING” is carried out. An area 904 is provided for displaying a button 904 to be pressed when “INSTRUCTION SHEET PRINTING” is carried out.

Referring back to the flowchart of FIG. 8, in step S807, the CPU 201 determines whether displaying of a screen other than the screen illustrated in FIG. 9 has been instructed, in other words, whether the “OTHER SETTINGS” button displayed in the area 902 has been pressed. If it is determined that displaying of another screen has been instructed (YES in step S807), the processing returns to step S804, in which the CPU 201 requests display data for displaying a relevant screen. If displaying of another screen has not been instructed (NO in step S807), the processing proceeds to step S808.

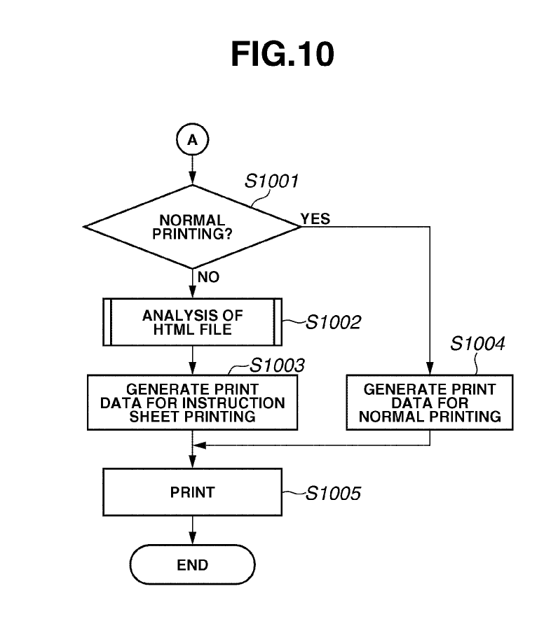

In step S808, the CPU 201 determines whether the user has given an output instruction, in other words, whether one of the buttons 903 and 904 has been pressed. If pressed (YES in step S808), the processing proceeds to the flowchart of FIG. 10 to execute printing of an operation screen displayed at that time. If neither of the buttons has been pressed (NO in step S808), the processing proceeds to step S809. In step S809, the CPU 201 determines whether the user has given an operation end instruction. If an operation end has been instructed (YES in step S809), the processing proceeds to step S810, in which the CPU 201 transmits instruction information indicating content of the instruction entered by the user using the operation screen to the refrigerator 110, then finishing the process.

In step S1001 of FIG. 10, the CPU 201 determines whether the button pressed in the screen of FIG. 9 is the button 903 or the button 904. “NORMAL PRINTING” is a mode for printing the screen illustrated in FIG. 9 as displayed. This mode is provided for carrying out processing similar to that of a printing function installed in a normal web browser. “INSTRUCTION SHEET PRINTING” is a mode for printing an instruction sheet to be filled in with a user's instruction, which is normally to be entered by using an operation screen displayed in a web browser.

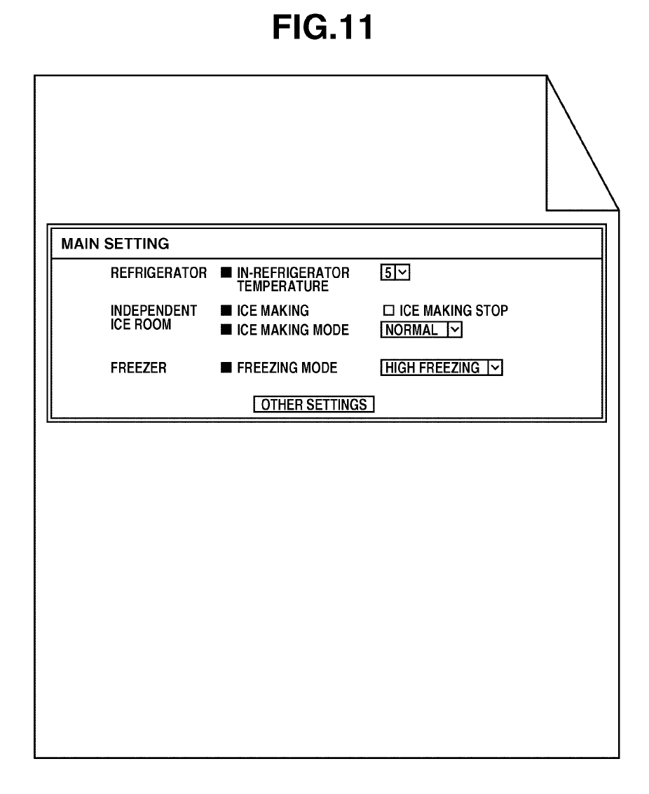

Upon determination in step S1001 that the normal printing has been instructed, in other words, if the button 903 of FIG. 9 is pressed (YES in step S1001), the processing proceeds to step S1004, in which the CPU 201 generates print data for normal printing, and executes printing by the printer 240 in step S1005. FIG. 11 illustrates an example of a print output in “NORMAL PRINTING”. In the case of “NORMAL PRINTING”, as illustrated in FIG. 11, the CPU 201 outputs an image similar to a screen displayed on the liquid crystal panel of the operation unit 220.

On the other hand, upon determination in step S1001 that normal printing has not been instructed, in other words, if the button 904 of FIG. 9 is pressed (NO in step S1001), the processing proceeds to step S1002, in which the CPU 201 analyzes an HTML file received from the refrigerator 110. Different from analysis executed to generate print data for normal printing in step S1004, the analysis of the HTML file executed here is provided for generating print data for outputting an instruction sheet.

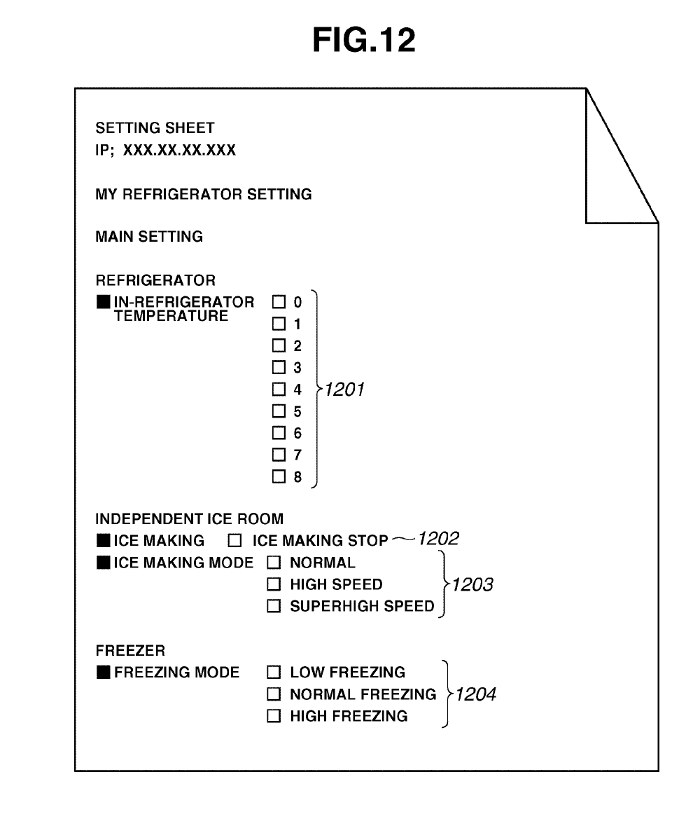

In step S1003, based on a result of the analysis executed in step S1002, the CPU 201 generates print data for instruction sheet printing, and executes printing by the printer 240 in step S1005. FIG. 12 illustrates an example of a print output in “INSTRUCTION SHEET PRINTING”. In the case of “INSTRUCTION SHEET PRINTING”, as illustrated in FIG. 12, an image different from the screen displayed on the liquid crystal panel of the operation unit 220 is output.

In an area 1201 of FIG. 12, check boxes for designating an in-refrigerator temperature to be set in the area 501 of FIG. 5 are printed in a list format. The user can control the refrigerator 110 to set a desired in-refrigerator temperature by filling one of the check boxes and causing the instruction sheet to be read with a method described below.

Areas 1202 to 1204 correspond to items to be set in the areas 502 to 504 of FIG. 5. As in the case of the area 1201, check boxes to be filled in with a user's instruction are printed.

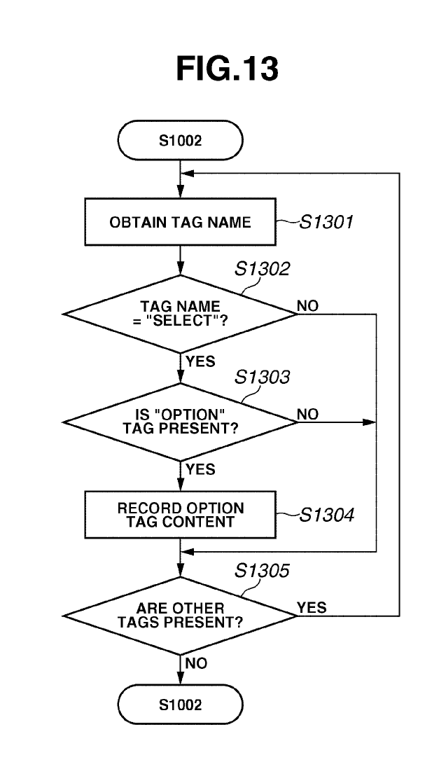

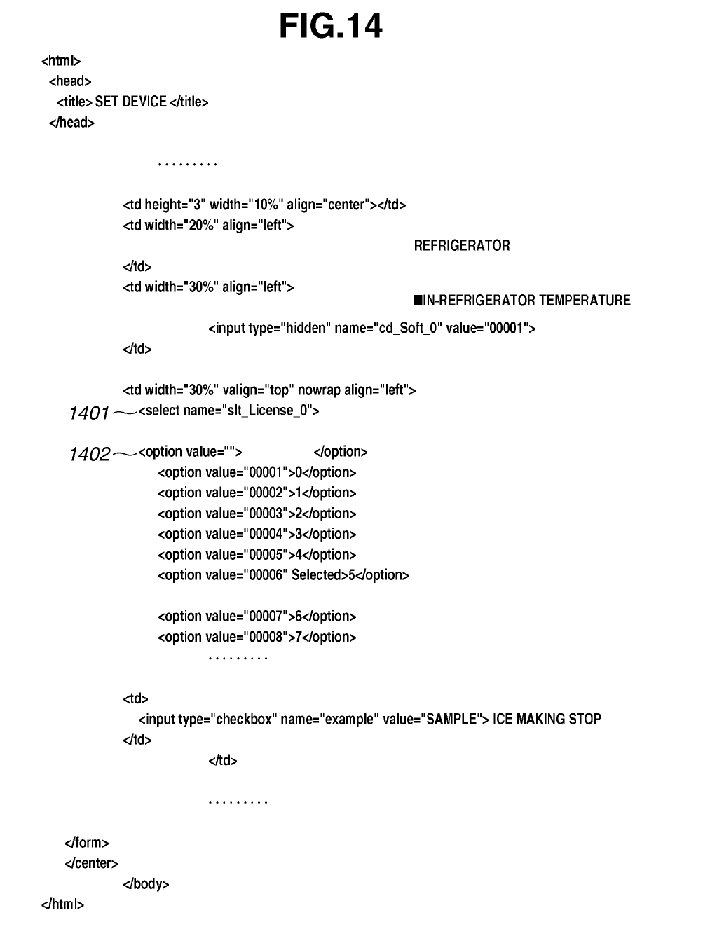

The analysis executed in step S1002 of FIG. 10 will be described below in detail. FIG. 13 is a flowchart of detailed processing of step S1002. The CPU 201 of the control unit 200 controls a series of operations of the flowchart based on programs stored in the HDD 204. FIG. 14 illustrates an example of an HTML file to be analyzed.

First, in step S1301, the CPU 201 obtains one of tags from the HTML file. In step S1302, the CPU 201 determines whether the tag obtained in step S1301 is a select tag. The select tag is written in a format similar to that of an area 1401 of FIG. 14. If the obtained tag is not a select tag (NO in step S1301), the processing proceeds to step S1305.

Upon determination in step S1302 that the obtained tag is a select tag (YES in step S1302), then in step S1303, the CPU 201 determines whether any option tag is present. The option tag is written in a format similar to that of an area 1402 of FIG. 14. In this case, option tags indicate options 0 to 8 prepared beforehand as in-refrigerator temperature options. If no option tag is present (NO in step S1303), the processing proceeds to step S1305.

Upon determination in step S1303 that an option tag is present (YES in step S1303), the processing proceeds to step S1304, in which the CPU 201 records content of the optional tag. In step S1305, the CPU 201 determines whether the HTML file contains other tags. If other tags are present (YES in step S1305), the processing returns to step S1301 to continue the process. Upon an end of processing of all of the tags contained in the HTML file, the CPU 201 finishes the analysis to return to the flowchart of FIG. 10.

In step S1003 of FIG. 10, based on the content recorded in step S1304 of FIG. 13, the CPU 201 writes the options described with the option tags in a list format and generates print data in which a check box is added to each option.

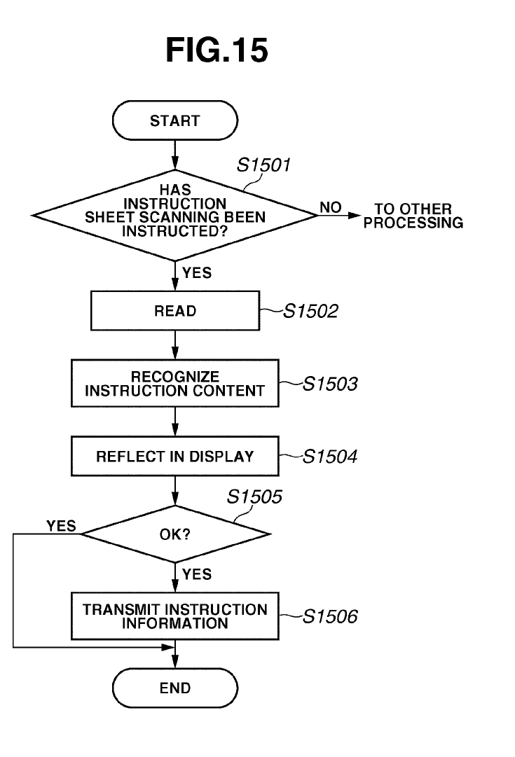

FIG. 15 is a flowchart specifically illustrating a series of operations where an instruction written by the user in the instruction sheet printed in step S1005 of FIG. 10 is read and transmitted to the refrigerator 110. The CPU 201 of the control unit 200 controls the series of operations of the flowchart based on programs stored in the HDD 204.

First, in step S1501, the CPU 201 determines whether the user has instructed scanning of the instruction sheet via the operation unit 220. If the user has instructed scanning of the instruction sheet (YES in step S1501), the processing proceeds to step S1502. If not (NO in step S1501), the CPU 201 executes other processing.

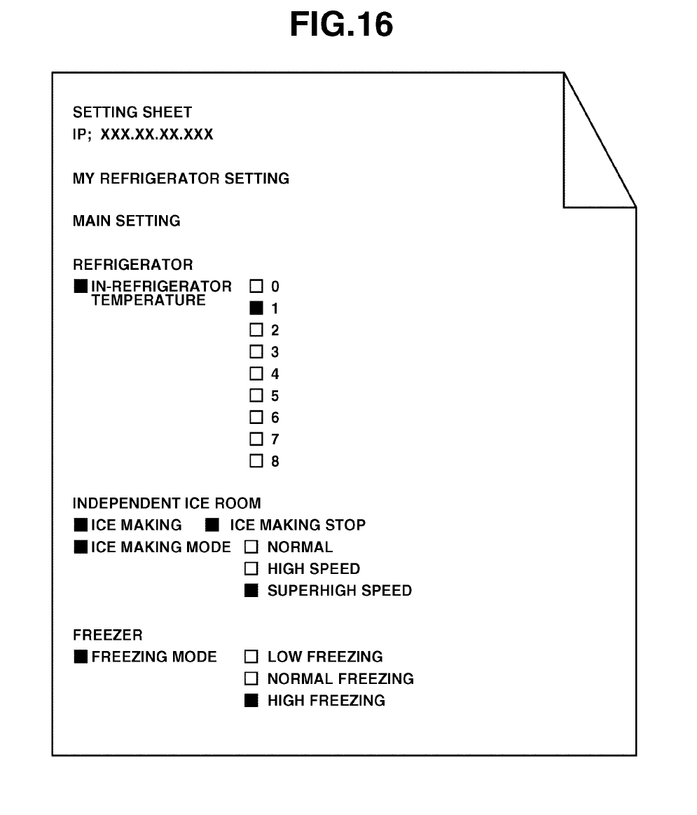

In step S1502, the CPU 201 operates the scanner 330 to read the instruction sheet filled in with a user's instruction. FIG. 16 illustrates an example of the instruction sheet filled in with a user's instruction. The user can fill in the instruction sheet by filling check boxes printed on the instruction sheet, as illustrated in FIG. 16.

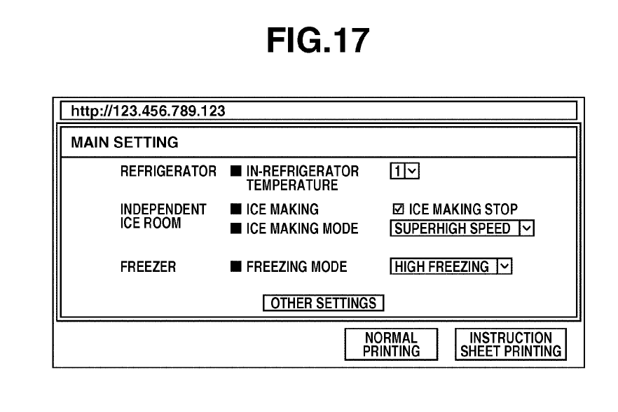

In step S1503, the CPU 201 recognizes content of the instruction written by the user based on the read instruction sheet. In step S1504, the CPU 201 reflects the content in a screen displayed on the liquid crystal panel of the operation unit 220. FIG. 17 illustrates an example of a screen in which the content of the user's instruction written in the instruction sheet illustrated FIG. 16 is reflected.

In step S1505, the CPU 201 asks the user whether the content displayed in step S1504 is correct and determines whether the user has made an entry indicating OK. If the user has made the entry indicating OK (YES in step S1505), the processing proceeds to step S1506, in which the CPU 201 transmits instruction information indicating content of the user's instruction to the refrigerator 110. Then, the CPU 201 terminates the processing. If the user has made an entry indicating NG (NO in step S1505), the CPU 201 terminates the processing without transmitting any instruction information to the refrigerator 110.

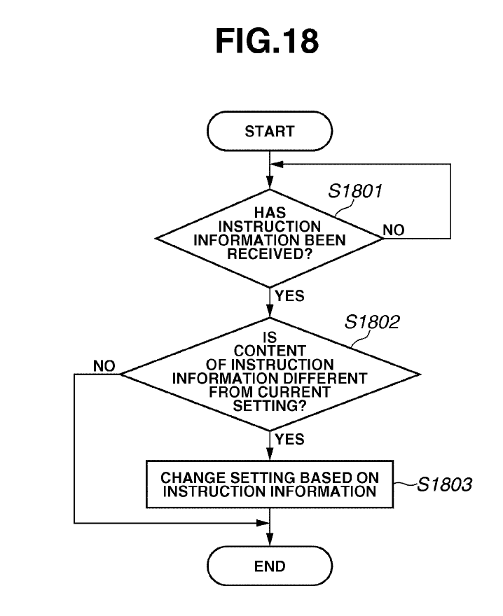

FIG. 18 is a flowchart specifically illustrating a series of operations where the control unit 301 of the refrigerator 110, which has received instruction information transmitted from the MFP 100, controls an operation of the refrigerator 110. The control unit 301 controls the series of operations of the flowchart based on programs stored in the memory 303.

First, in step S1801, the control unit 301 monitors reception of the instruction information from the MFP 100. Upon reception of the instruction information (YES in step S1801), the processing 301 proceeds to step S1802, in which the control unit 301 determines whether content of the received instruction information is different from the current setting of the refrigerator 110. If the content of the instruction information agrees with the current setting (NO in step S1802), the control unit 301 terminates the processing.

On the other hand, if the content of the instruction information is different from the current setting (YES in step S1802), the processing proceeds to step S1803, in which the control unit 301 changes the setting of the refrigerator 110 based on the content of the instruction information. Then, the control unit 301 terminates the processing.

As described above, according to the first exemplary embodiment, first, the MFP 100 obtains display data used when an operation screen is displayed from the refrigerator 110. Then, the MFP 100 analyzes the obtained display data based on an instruction from the user and outputs an instruction sheet to be filled in with a user's instruction. After the user writes an instruction in the output instruction sheet, the MFP 100 reads the instruction sheet using the scanner 230 to recognize the user's instruction. Then, the MFP 100 transmits instruction information indicating content of the user's instruction to the refrigerator 110. The control unit 301 of the refrigerator 110, which has received the instruction information, controls an operation of the refrigerator 110 based on the instruction information.

Accordingly, without operating a complex terminal, such as a PC, whose operation is complex, a user can easily give instructions to an information processing apparatus (for example, the refrigerator 110) from a remote place. Thus, usability can be improved. When outputting the instruction sheet, the MFP 100 prints options, which would not be printed in normal printing, together with check boxes in a list format. Thus, the MFP 100 can output an instruction sheet easily understandable by a user.

The MFP 100 in the first exemplary embodiment includes two output modes, for example, a normal printing mode for outputting data in a layout displayed as an operation screen and an instruction sheet printing mode for converting data into a format of an instruction sheet and outputting the instruction sheet. Thus, the user can select and execute a desired output mode.

As described above, in the web browser installed in the operation unit 220 of the MFP 100, an operation screen based on an HTML file obtained from the refrigerator 110 is first displayed, and then the instruction sheet is output. However, other arrangements can be employed. Specifically, when a printer that does not include a display unit for displaying an operation screen is used as an image forming apparatus, the printer can automatically analyze an obtained HTML file without displaying an operation screen based on the HTML file and can output an instruction sheet.

### Second Exemplary Embodiment

A second exemplary embodiment of the present invention is be described below. The first exemplary embodiment has been described by way of example where an instruction sheet corresponding to one of the main screen illustrated in FIG. 5 and the detailed screen illustrated in FIG. 7 is output. The second exemplary embodiment is described about a case where a plurality of screens are automatically integrated to output a single instruction sheet. A basic configuration of the second exemplary embodiment is similar to that of the first exemplary embodiment, and thus a detailed description thereof will not be repeated. Differences of the second exemplary embodiment from the first exemplary embodiment will be described below.

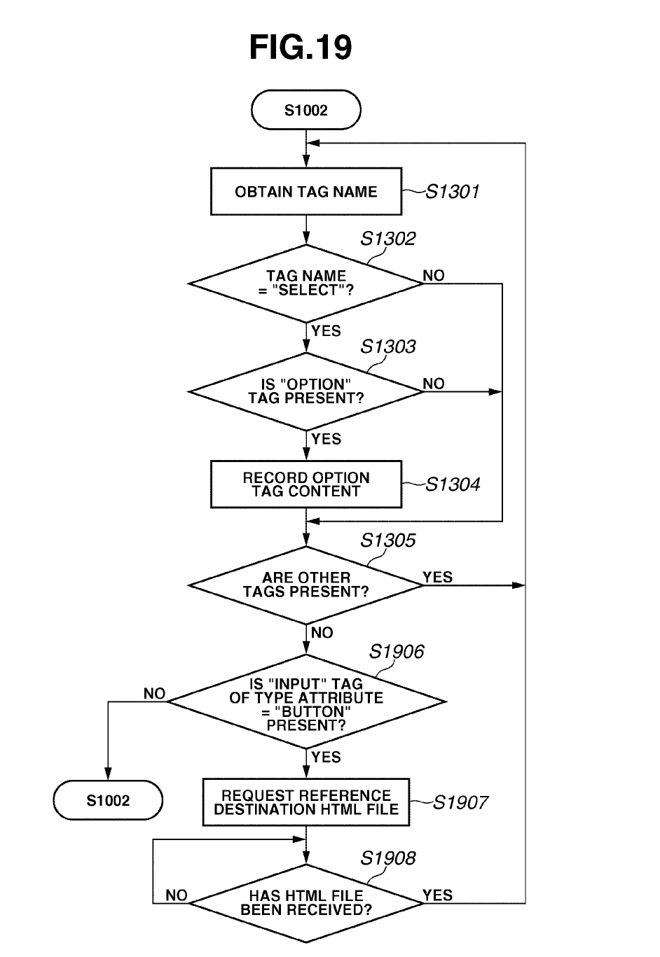

FIG. 19 is a flowchart illustrating analysis of an HTML file according to the second exemplary embodiment, which corresponds to that of FIG. 13. The CPU 201 of the control unit 200 controls a series of operations of the flowchart based on programs stored in the HDD 204.

Steps S1301 to S1305 in FIG. 19 correspond to steps S1301 to S1305 in FIG. 13, and thus a description thereof will not be repeated. If processing has been finished for all of the tags in steps S1301 to S1305, then in step S1906, the CPU 201 determines whether there is any input tag whose type attribute is “button”.

If a result of the determination in step S1906 indicates that a relevant tag is present (YES in step S1906), then in step S1907, the CPU 201 requests an HTML file corresponding to a reference destination indicated by the tag. Specifically, if a button such as “OTHER SETTINGS” of the screen of FIG. 5 is present, the CPU 201 requests an HTML file that is a link destination of the button, for example, an HTML file to be used for displaying the screen illustrated in FIG. 7. If a result of the determination in step S1906 indicates that no relevant tag is present (NO in step S1906), the CPU 201 terminates the analysis.

In step S1908, the CPU 201 determines whether the HTML file requested in step S1907 has been received. If received (YES in step S1908), the processing returns to step S1301 to execute the analysis in steps S1301 to S1305 for the received HTML file.

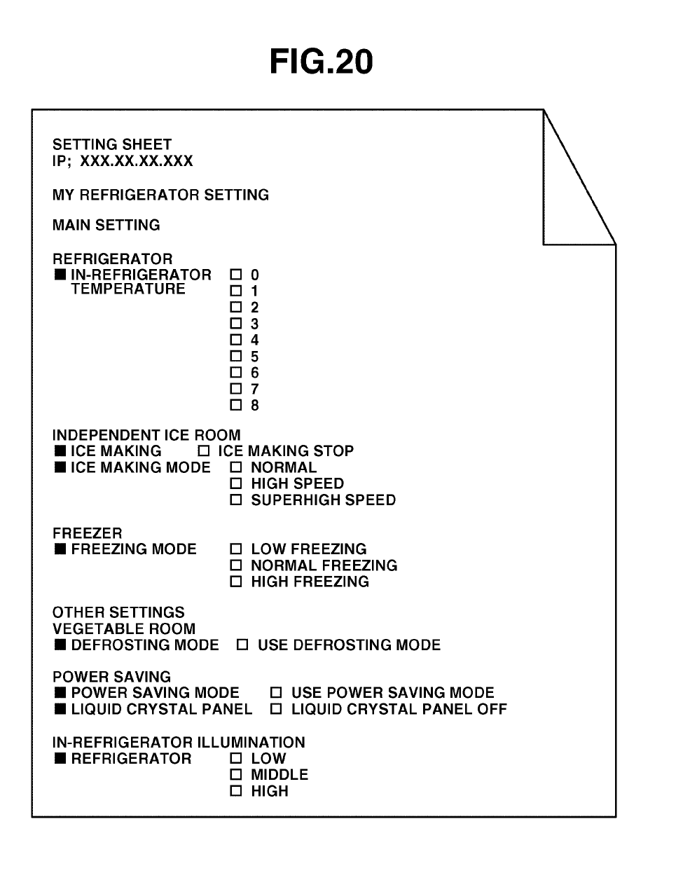

FIG. 20 illustrates an example of an instruction sheet output in step S1005 of FIG. 10 as a result of the analysis illustrated in FIG. 19. As illustrated in FIG. 20, the instruction sheet output according to the second exemplary embodiment contains items corresponding to both the main screen illustrated in FIG. 5 and the detailed screen illustrated in FIG. 7.

Additionally, if the user can instruct whether to integrate items of a plurality of screens based on an HTML file into one instruction sheet to be output, usability can be further improved.

As described above, according to the second exemplary embodiment, items of a plurality of screens based on an HTML file are integrated into one instruction sheet to be output. Thus, even when an operation screen is hierarchized, the user can output an instruction sheet without any burdensome work.

### Third Exemplary Embodiment

A third exemplary embodiment of the present invention is described below. According to the first exemplary embodiment, display data used for displaying an operation screen to give instructions to an information processing apparatus (for example, the refrigerator 110) on a network is analyzed to output an instruction sheet. According to the third exemplary embodiment, display data used for displaying an operation screen to give instructions to an MFP 100 is obtained from a server apparatus on a network, and an instruction sheet is output from the MFP 100.

A basic configuration of the third exemplary embodiment is similar to that of the first exemplary embodiment, and thus a detailed description thereof will not be repeated. Differences of the third exemplary embodiment from the first exemplary embodiment will be described below.

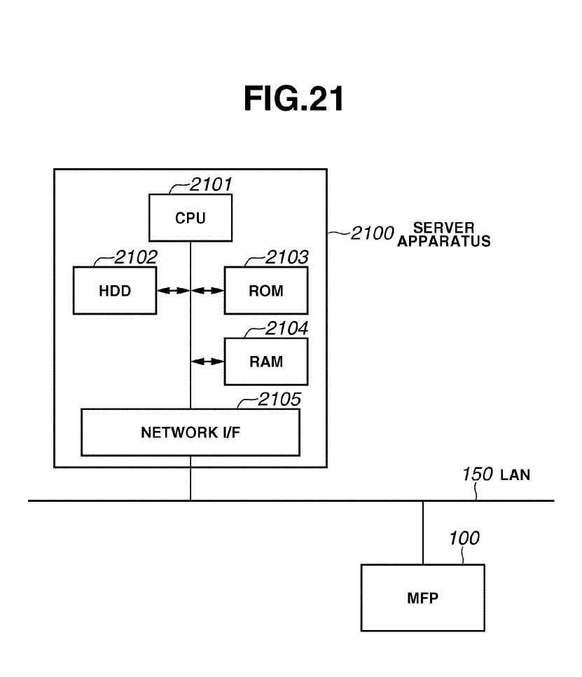

FIG. 21 illustrates an entire system according to the third exemplary embodiment. An MFP 100, which is similar to that described in the first and second exemplary embodiments, is connected to a server apparatus 2100 via a LAN 150. The server apparatus 2100 includes a CPU 2101. The CPU 2101 activates the server apparatus 2100 based on a boot program stored in a ROM 2103.

The CPU 2101 reads various control programs stored in an HDD 2102 to execute various processes by using a RAM 2104 as a work area. The CPU 2101 is connected to the LAN 150 via a network I/F 2105.

The HDD 2102 stores display data for an operation screen to be displayed on a liquid crystal panel of an operation unit 220 of the MFP 100 in HTML format. The CPU 2101 transmits the display data to the MFP 100 in response to a request from the MFP 100. Thus, by storing the display data for an operation screen to be displayed in the MFP 100 in the HDD of the server apparatus 2100, a memory capacity necessary for the MFP 100 itself can be reduced.

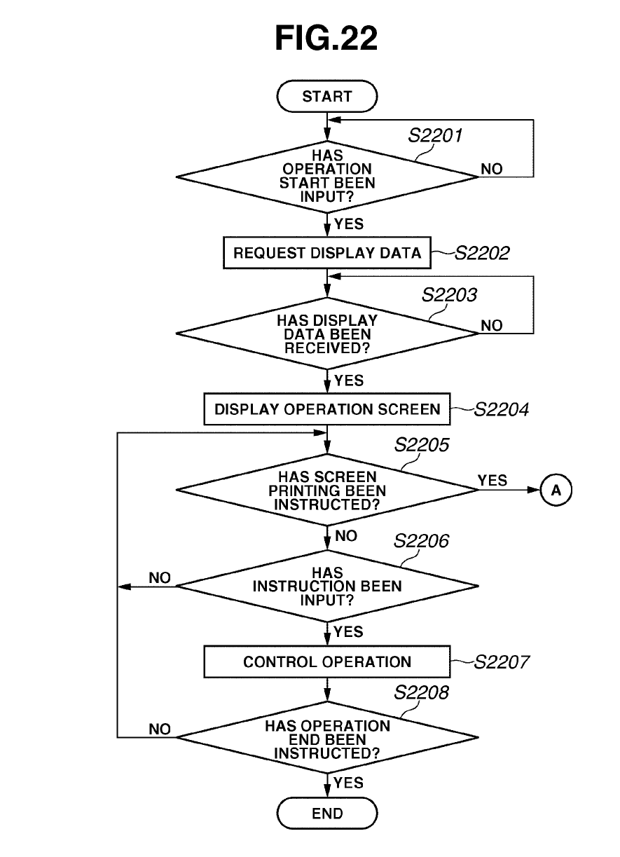

FIG. 22 is a flowchart specifically illustrating a series of operations where the MFP 100 of the third exemplary embodiment obtains and analyzes display data used when an operation screen is displayed from the server apparatus 2100 and prints and outputs an instruction sheet.

First, in step S2201, the CPU 2101 determines whether a user has made an entry of an operation start. Upon determination that the user has made an entry of an operation start (YES in step S2201), the processing proceeds to step S2202, in which the CPU 2101 requests display data to the server apparatus 2100.

In step S2203, the CPU 2101 determines whether the display data requested in step S2202 has been received from the server apparatus 2100. If received (YES in step S2203), the processing proceeds to step S2204, in which the CPU 2101 displays an operation screen based on the received display data.

In step S2205, the CPU 2101 determines whether the user has instructed printing of the operation screen. Upon determination that the user has instructed printing of the operation screen (YES in step S2205), the processing proceeds to the flowchart of FIG. 10, in which the MFP 100 outputs an instruction sheet as described in first exemplary embodiment.

On the other hand, if it is determined in step S2205 that the user has not instructed printing of the operation screen (NO in step S2205), the processing proceeds to step S2206, in which the CPU 2101 determines whether the user has entered an instruction by using the displayed operation screen. If the user has entered an instruction (YES in step S2206), the processing proceeds to step S2207, in which the CPU 2101 controls an operation of the MFP 100 based on the user's instruction. If it is determined in step S2206 that the user has not entered any instruction (NO in step S2206), the processing returns to step S2205.

In step S2208, the CPU 2101 determines whether the user has instructed an operation end. If the user has instructed an operation end (YES in step S2208), the CPU 2101 finishes the processing. If not (NO in step S2208), the processing returns to step S2205.

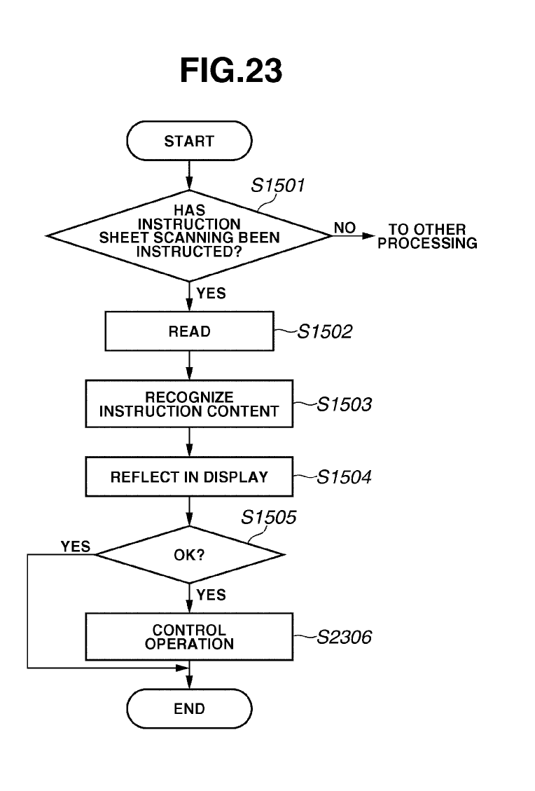

FIG. 23 is a flowchart specifically illustrating a series of operations where an instruction written in the instruction sheet printed in step S1005 of FIG. 10 by the user is read to control an operation of the MFP 100. The CPU 201 of the control unit 200 controls the series of operations of the flowchart based on programs stored in the HDD 204.

Steps S1501 to S1505 in FIG. 23 are similar to steps S1501 to S1505 in FIG. 15, and thus a detailed description thereof will not be repeated. In step S2306, the CPU 201 controls an operation of the MFP 100 based on content of the instruction from the user recognized in step S1503.

As described above, according to the third exemplary embodiment, a display data obtained from a server apparatus is analyzed to output an instruction sheet. The instruction sheet, in which a user's instruction has been written, is read to recognize content of an instruction from the user. Thus, the operation of the MFP 100 itself is controlled according to the content of the instruction.

Thus, even when giving instructions to an apparatus itself where an operation screen is displayed by using display data, such as an HTML file, the user can easily give instructions without any complex operation using the operation screen. As a result, usability can be improved.

The first to third exemplary embodiments have been described using a case where an instruction sheet for instructing an operation of an information processing apparatus or an image forming apparatus on a network is output. However, the present invention can employ other arrangements. In other words, by applying the invention when various applications or registrations are carried out by using a web site on the Internet, the user can easily enter an instruction. As a result, usability can be improved.

The first to third exemplary embodiments have been described using an example where an HTML file is used as display data. However, the display data can be markup languages of other formats, such as a file of Extensible Markup Language (XML). By carrying out the processes of the first to third exemplary embodiments for an HTML file or an XML file, the above-described functions can be applied to general-purpose display data. Instead of a general-purpose format, such as an HTML file or an XML file, display data written in dedicated language can be analyzed using a dedicated analysis method.

The functions of the first to third exemplary embodiments can be provided independently or in combination as occasion demands.

### Other Exemplary Embodiments

The present invention can be directed to, for example, a system, an apparatus, a method, a program, or a storage medium (recording medium). Specifically, the invention can be applied to a system that includes a plurality of devices, or an apparatus that includes a single device.

Programs (programs corresponding to the illustrated flowcharts of the exemplary embodiments) of software for realizing the functions of the exemplary embodiments are supplied to the system or the apparatus directly or from a remote place. A computer of the system or the apparatus reads supplied program code to execute the programs.

Accordingly, the program code installed in the computer to realize the functions of the exemplary embodiments also realize the invention. In other words, the invention includes a computer program to realize the functions.

In this case, the program can be object code, a program executed by an interpreter, or script data supplied to an operating system (OS) as long as it has a program function.

A computer-readable recording medium for supplying a program includes, for example, a floppy disk, a hard disk, an optical disk, a magneto-optical disk, an magneto optical (MO) disk, a compact disk-ROM (CD-ROM), a CD-recordable (CD-R), a CD-rewritable (CD-RW), a magnetic tape, a nonvolatile memory card, a ROM, and a digital versatile disk (DVD (DVD-ROM or DVD-R)).

As a program supplying method, a program can be supplied by using a browser of a client computer to download the program to a recording medium, such as a hard disk, from a web page on the Internet. In other words, the computer is connected to the web page, and a computer program or a compressed file including an automatic installation function is downloaded to the computer. A program supplying method can also be realized by dividing program code of a program into a plurality of files and downloading the files from different web pages. In other words, a World Wide Web (WWW) sever that controls a plurality of users to download program files to realize the functions of the exemplary embodiments by a computer is also included in the invention.

The program of the exemplary embodiments can be encrypted to be stored in a storage medium, such as a CD-ROM, and distributed to users. The user who has satisfied predetermined conditions is allowed to download key information to decrypt the program from a web page via the Internet. Then, by using the key information, the user can execute the encrypted program to install the program on a computer.

The aforementioned functions of the exemplary embodiments are realized by executing the read program via the computer. In addition, based on instructions of the programs, an OS operating in the computer carries out a part or the whole of the actual process, and this process can realize the above-described functions of the exemplary embodiments.

Furthermore, the functions of the exemplary embodiments can be realized after a program read from the storage medium is written in a memory of a function extension board inserted into the computer or a function extension unit connected to the computer. In other words, the functions of the exemplary embodiments can be realized by carrying out a part or the whole of the actual process via a CPU of the function extension board or the function extension unit based on the program instruction.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-097486 filed Apr. 3, 2007, which is hereby incorporated by reference herein in its entirety.

What is claimed is:

1. A remote instruction system comprising:
an information processing apparatus; and
an image forming apparatus,
wherein the information processing apparatus and the image forming apparatus are interconnected via a network,
wherein the information processing apparatus includes:
a storage unit configured to store display data to be used when an operation screen for entering an instruction to be given to the information processing apparatus is displayed;
a display data transmission unit configured to transmit the display data stored in the storage unit to an external apparatus in response to a request from the external apparatus;
an instruction information receiving unit configured to receive, from the external apparatus, instruction information indicating content of an instruction entered by a user using the operation screen displayed based on the display data in the external apparatus; and
a control unit configured to control an operation of the information processing apparatus based on the instruction information received by the instruction information receiving unit, and
wherein the image forming apparatus includes:
a display data receiving unit configured to receive the display data from the information processing apparatus;
an analysis unit configured to analyze the display data received by the display data receiving unit;
an output unit configured to output a first instruction sheet to be filled in with an instruction to the information processing apparatus according to a result of analysis by the analysis unit;
a reading unit configured to read a second instruction sheet that is the first instruction sheet output by the output unit and filled in with a user's instruction; and
an instruction information transmission unit configured to transmit, to the information processing apparatus, instruction information indicating content of the user's instruction recognized from the second instruction sheet read by the reading unit.

2. The remote instruction system according to claim 1, wherein the image forming apparatus comprises a multifunction peripheral, and the information processing apparatus comprises a household electric appliance.

3. An image forming apparatus connectable to an information processing apparatus via a network, the image forming apparatus comprising:
an acquisition unit configured to acquire display data to be used when an operation screen for entering an instruction to be given to the information processing apparatus is displayed;
an analysis unit configured to analyze the display data acquired by the acquisition unit; an output unit configured to output a first instruction sheet to be filled in with an instruction to the information processing apparatus according to a result of analysis by the analysis unit;
a reading unit configured to read a second instruction sheet that is the first instruction sheet output by the output unit and filled in with a user's instruction; and
a transmission unit configured to transmit, to the information processing apparatus, instruction information indicating content of the user's instruction recognized from the second instruction sheet read by the reading unit.

4. The image forming apparatus according to claim 3, wherein the display data includes a file of HyperText Markup Language (HTML) format.

5. The image forming apparatus according to claim 3, further comprising a requesting unit configured to request the display data to the information processing apparatus,
wherein the acquisition unit is configured to receive and acquire the display data from the information processing apparatus.

6. The image forming apparatus according to claim 3, wherein, if items to be instructed in the operation screen displayed using the display data include an item in which one option is selectable from among a plurality of options, the output unit is configured to output the first instruction sheet in which the plurality of options are written in a list format.

7. The image forming apparatus according to claim 6, wherein the output unit is configured to output the first instruction sheet in which a plurality of check boxes corresponding to the plurality of options are written, and
wherein the transmission unit transmits, as the instruction information, information indicating an option corresponding to a check box selected by the user from among the plurality of check boxes.

8. The image forming apparatus according to claim 3, further comprising a display unit configured to display the operation screen using the display data obtained by the acquisition unit,
wherein, when receiving an output instruction from a user while the display unit displays the operation screen, the output unit outputs the first instruction sheet.

9. The image forming apparatus according to claim 8, wherein, after the reading unit reads the second instruction sheet, the display unit displays the operation screen in which the user's instruction written in the second instruction sheet is reflected.

10. The image forming apparatus according to claim 3, further comprising a selection unit configured to select one of a first output mode for outputting the operation screen in a layout displayed by the display unit and a second output mode for outputting the operation screen as the first instruction sheet,
wherein, when the selection unit selects the second output mode, the output unit outputs the first instruction sheet.

11. An image forming apparatus connectable to a server apparatus via a network, the image forming apparatus comprising:
a requesting unit configured to request display data to be used when an operation screen for entering an instruction to be given to the image forming apparatus is displayed to the server apparatus;
a display unit configured to display the operation screen based on the display data transmitted from the server apparatus in response to a request from the requesting unit;
an analysis unit configured to analyze the display data transmitted from the server apparatus;
an output unit configured to output a first instruction sheet to be filled in with an instruction to the image forming apparatus according to a result of analysis by the analysis unit;
a reading unit configured to read a second instruction sheet that is the first instruction sheet output by the output unit and filled in with a user's instruction; and
a control unit configured to control an operation of the image forming apparatus according to one of content instructed by a user via the operation screen displayed by the display unit and information indicating the user's instruction recognized from the second instruction sheet read by the reading unit.

12. The image forming apparatus according to claim 11, wherein the server apparatus includes a web server apparatus configured to store the display data in HyperText Markup Language (HTML) format.

13. An image forming apparatus connectable to a web server apparatus via a network, the image forming apparatus comprising:
a requesting unit configured to request a HyperText Markup Language (HTML) file stored in the web server apparatus to the web server apparatus;
a receiving unit configured to receive the HTML file transmitted from the web sever apparatus in response to a request from the requesting unit;
an analysis unit configured to analyze the HTML file received by the receiving unit;
an output unit configured to output a first instruction sheet to be filled in with a user's instruction according to a result of analysis by the analysis unit;
a reading unit configured to read a second instruction sheet that is the first instruction sheet output by the output unit and filled in with the user's instruction; and
a transmission unit configured to transmit, to the web server apparatus, information indicating the user's instruction recognized from the second instruction sheet read by the reading unit.

14. A method for controlling an image forming apparatus connected to an information processing apparatus via a network, the method comprising:
acquiring display data to be used when an operation screen for entering an instruction to be given to the information processing apparatus is displayed;
analyzing the acquired display data;
outputting a first instruction sheet to be filled in with an instruction to the information processing apparatus according to a result of the analyzing;
reading a second instruction sheet that is the output first instruction sheet filled in with a user's instruction; and
transmitting, to the information processing apparatus, instruction information indicating content of the user's instruction recognized from the read second instruction sheet.

15. A method for controlling an image forming apparatus connected to a server apparatus via a network, the method comprising:
requesting display data to be used when an operation screen for entering an instruction to be given to the image forming apparatus is displayed to the server apparatus;
displaying the operation screen based on the display data transmitted from the server apparatus in response to the requesting;
analyzing the display data transmitted from the server apparatus;
outputting a first instruction sheet to be filled in with an instruction to the image forming apparatus according to a result of the analyzing;
reading a second instruction sheet that is the output first instruction sheet filled in with a user's instruction; and
controlling an operation of the image forming apparatus according to one of content instructed by a user via the displayed operation screen and information indicating the user's instruction recognized from the read second instruction sheet.

16. A method for controlling an image forming apparatus connected to a web server apparatus via a network, the method comprising:
requesting a HyperText Markup Language (HTML) file stored in the web server apparatus to the web server apparatus;
receiving the HTML file transmitted from the web sever apparatus in response to the requesting;
analyzing the received HTML file;
outputting a first instruction sheet to be filled in with a user's instruction according to a result of the analyzing;
reading a second instruction sheet that is the output first instruction sheet filled in with the user's instruction; and
transmitting, to the web server apparatus, information indicating the user's instruction recognized from the read second instruction sheet.

17. A computer-readable storage medium storing instructions which, when executed by an apparatus, cause the apparatus to perform the method according to claim 14.

18. A computer-readable storage medium storing instructions which, when executed by an apparatus, cause the apparatus to perform the method according to claim 15.

19. A computer-readable storage medium storing instructions which, when executed by an apparatus, cause the apparatus to perform the method according to claim 16.
